(19) United States
(12) Patent Application Publication
(10) Pub. No.: US 2023/0333894 A1
(43) Pub. Date: Oct. 19, 2023

(54) DYNAMIC ALLOCATION OF STACK MEMORY SPACE UPON THREAD START IN A DISTRIBUTED PROCESSING ENVIRONMENT

(71) Applicant: Micron Technology, Inc., Boise, ID (US)

(72) Inventors: Christopher Baronne, Allen, TX (US); Tony M. Brewer, Plano, TX (US)

(21) Appl. No.: 17/721,578

(22) Filed: Apr. 15, 2022

(51) Int. Cl. G06F 9/50; G06F 9/30

(52) U.S. Cl. CPC G06F 9/5016; G06F 9/5022; G06F 9/3009

(57) ABSTRACT

Disclosed in some examples are methods, systems, devices, and machine-readable mediums which utilize a pool method whereby a host process executing on the host processor reserves one or more pools of memory for worker threads of the host process. Upon creation of a new thread corresponding to the host process, the worker processor executing the new thread may assign a portion of the previously reserved pool to the new thread. By giving some control to a worker processor to assign memory from a previously reserved pool, threads may be assigned memory resources without additional message overhead from the host processor to the worker processor while at the same time retaining overall memory control with the host processor.

### GOVERNMENT RIGHTS

This invention was made with U.S. Government support under Agreement No. DE-AC05-76RL01830, awarded by the US Department of Energy. The U.S. Government has certain rights in the invention.

### TECHNICAL FIELD

Embodiments pertain to computer architectures. Some embodiments relate to dynamic allocation of memory space upon thread start.

### BACKGROUND

Software programs executing on processors utilize working memory such as Random-Access Memory (RAM) to store variables, function call addresses, return addresses, passing parameters to other processes or functions, and the like. One type of memory allocated to software may be stack memory. Stack memory is memory that is a first-in-last-out memory where new items are “pushed” onto the top of the stack and items read from the stack are “popped” off the top of the stack. The stack memory thus is like a stack of plates—where the plate that is stacked last is typically the plate that is taken off the stack of plates first. Stack space is typically assigned prior to the execution of a new thread. For single processor environments, this is typically done by a memory controller on the processor. For systems in which processors are distributed, the memory allocation process is more complex.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a diagram of a computing system according to some examples of the present disclosure.

FIG. 2 illustrates a logical flow of reserving a stack pool according to some examples of the present disclosure.

FIG. 3 illustrates a flowchart of a method of allocating memory, such as stack memory, for threads of a host process according to some examples of the present disclosure.

FIG. 4 illustrates a flowchart of a method of a thread executing on a worker processor according to some examples of the present disclosure.

FIG. 5 illustrates a flowchart of a method of releasing the pool of reserved memory for the host application according to some examples of the present disclosure.

FIG. 6 is a block diagram illustrating an example of a machine upon which one or more embodiments may be implemented.

### DETAILED DESCRIPTION

In distributed processing environments, a host processor may execute a host process which may distribute work to other processors (hereinafter worker processors) in the form of worker threads. In some examples, these worker processors may be on a peripheral card or device and may be accessible to the host processor through an interface, such as a Peripheral Component Interconnect Express (PCI-e), a Universal Serial Bus (USB), a network-on-chip interface, or the like. In some examples, these worker processors may have access to dedicated memory on the peripheral card or device. The dedicated memory on the peripheral card or device may be managed by driver software executing on the host processor.

In traditional architectures, the host process manages and controls all the worker threads. That is, the host process is responsible for spawning the worker thread, allocating its resources, and cleaning up those resources when the thread is done executing. For example, a thread may be created by the host processor by sending one or more messages to the peripheral card, including the thread instructions that is to be executed by one of the worker processors. When creating a worker thread, the host processor also allocates working memory for the thread from the local memory accessible by the worker processor. For example, stack memory for storing data may be allocated by one or more function calls to the driver software. The driver software may then communicate with the peripheral card or device to assign this memory.

This process is slow and time consuming as each new thread creation requires messaging to the peripheral card to setup the thread and allocate memory. When a process or application spawns a large number of worker threads the overhead of creating a thread and setting up its stack space adds up to a considerable amount of wasted interface bandwidth and latency. Thus, a technical problem exists because each thread spawn thus requires significant messaging overhead across a system bus and a significant amount of latency before the thread may begin execution.

In some examples, threads executing on the worker processors may be spawned independently of the host process. This removes the need for the host process to explicitly create all threads and gives additional control to each individual thread. Unfortunately, because the host processor is still managing the memory resources, messages still need to be communicated back to the host processor to allocate stack memory for the newly created thread. Thus, while independent creation of new threads may reduce some of the overhead associated with this distributed compute architecture, it does not eliminate the overhead altogether. Moving memory management down to the peripheral card may solve this problem, however, it may create additional issues. First, as these cards may have multiple worker processors, this would add additional complexity and cost as some form of memory management would have to be implemented by the peripheral card to manage contention between the worker processors for the shared memory. Second, this solution would remove control from the host processor and inhibit the ability of the host process to manage resources.

Disclosed in some examples are methods, systems, devices, and machine-readable mediums which utilize a pool method whereby a host process executing on the host processor reserves one or more pools of memory for worker threads of the host process. In some examples, each reserved pool may be specific to a worker processor and may be assigned to threads executing only on that worker processor to avoid contention issues. That is, each worker processor that is going to execute worker threads for the host process will be assigned a pool of memory from which the worker processor can allocate to worker threads corresponding to the host process. Upon creation of a new thread corresponding to the host process, the worker processor executing the new thread may assign a portion of the previously reserved pool to the new thread. By giving some control to a worker processor to assign memory from a previously reserved pool, threads may be assigned memory resources without additional message overhead from the host processor to the worker processor while at the same time retaining overall memory control with the host processor. This provides a technical solution to the technical problem of increased latency resulting from allocation of memory to threads of a process by pre-allocation of memory pools for use by threads of a process.

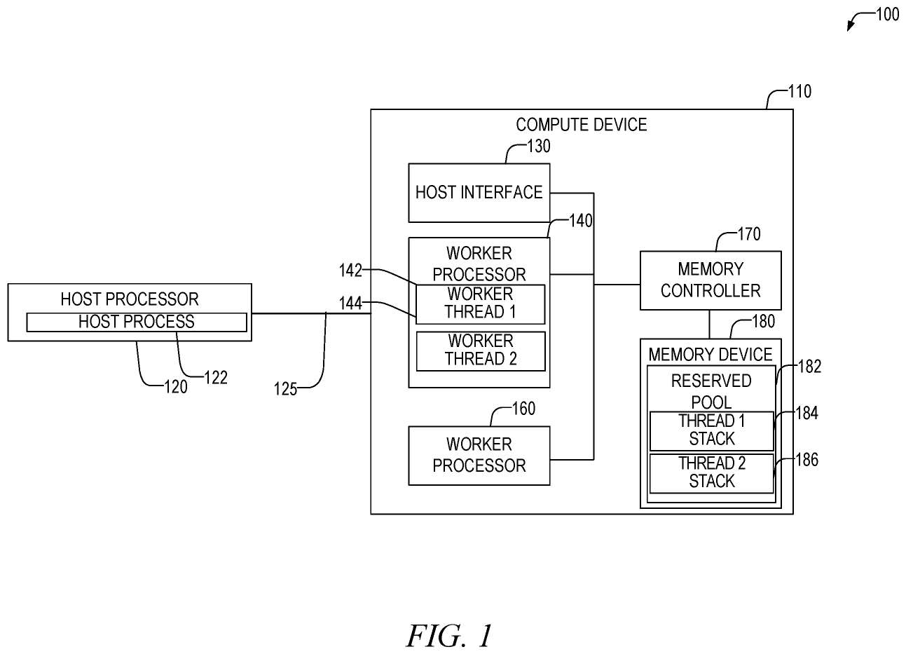

FIG. 1 illustrates a diagram of a computing system 100 according to some examples of the present disclosure. The host processor 120 may communicate with a compute device 110 across a host interface 125. In some examples, the host processor 120 may communicate directly with the compute device 110 as shown, but in other examples, the communication may be indirect, such as via a platform controller, a chipset component, or the like. Host interface 125 may be a PCIe bus, a USB bus, a packet-based bus, a network interface (e.g., such as a packet-based network), or any other communication interface. While the compute device 110 is shown as a separate peripheral card, in other examples, the compute device 110 may be on a same circuit board or even a same semiconductor package as the host processor 120. As used herein, the host process may be an instance of a software program that is being executed on the host processor 120.

Compute device 110 may include a host interface 130 for managing communications with the host processor 120. In some examples, a host interface on the host processor side may be part of the host processor 120 (although not shown) or may be part of a different circuit, such as a platform controller or chipset (not shown). The host interface 130 provides for communicating across host interface 130 and includes implementing one or more communication protocols.

Compute device 110 may include one or more worker processors, such as worker processors 140 and 160. Worker processors may be any processor that can execute instructions and the term worker refers to the use of the processor as providing processing resources that are assigned work by a host processor. Worker processors may be processors implementing a Reduced Instruction Set Computer (RISC) architecture, such as a RISC-V architecture, an Advanced RISC Machines (ARM) architecture, or the like. In other examples, worker processors 140 and 160 may implement a Complex Instruction Set Computer (CISC) architecture, such as an x86 architecture, or the like. In some examples, the worker processors 140 and/or 160 may be general purpose processors, customized general-purpose processors designed to accelerate certain tasks, wholly customized processors that perform only certain tasks (e.g., a Field Programmable Gate Array FPGA), or the like.

Host processor 120 may be a general-purpose processor, a customized general-purpose processor designed to accelerate certain tasks, a wholly customized processor that performs only certain tasks (e.g., a Field Programmable Gate Array FPGA), or the like. In some examples, the host processor 120 may be of a Reduced Instruction Set Computer (RISC) architecture, such as a RISC-V architecture, an Advanced RISC Machines (ARM) processor, or the like. In other examples, host processor 120 may be a Complex Instruction Set Computer (CISC) architecture such as an x86 architecture, or the like. The term “host” in host processor refers to the host processor executing the host process.

Compute device 110 may include a memory controller 170 which may control one or more memory devices such as memory device 180. In some examples, the functions of the memory controller 170 may be part of one or more of the processors of the compute device. Memory device 180 may include one or more volatile or non-volatile memories, such as Random-Access Memory (e.g., Synchronous Dynamic RAM-SDRAM), flash memory, phase change memory, or the like. Memory in the memory device 180 may be shared amongst the worker processors 140 and 160.

The host process 122 executing on the host processor 120 may reserve one or more processors of the compute device 110 to execute one or more instructions of the host process 122 as one or more worker threads. For example, the host processor may start a worker thread on a previously reserved worker processor using a thread start message that includes, or points to, the code to execute. The worker processor then begins execution of the indicated code.

The threads executing on the worker processors (e.g., worker processor 140 or 160) of the compute device 110 may spawn additional worker threads that execute on one or more of the reserved processors of the compute device 110. In some examples, the host processor allocates one or more memory pools, such as reserved pool 182 for use by the worker threads on the compute device 110. In some examples, the memory of the compute device 110 may be managed by a device driver executing on the host processor (not shown). The memory may be allocated using inter-process communication, application programming interfaces (APIs), function calls, or the like by host process 122 messaging the device driver. In these examples, upon reserving a processor for execution of the host process 122, the processor may be informed of the address of the reserved pool 182 and a size of the reserved pool 182. In other examples, the memory may be managed on the compute device 110, and the memory allocated using a message across host interface 125 to memory controller 170 and/or worker processors 140 and 160.

In some examples, the reserved pool may be specific to a processor. Thus, a first reserved pool, such as reserved pool 182 may be specific to a particular processor of the compute device 110—for example, worker processor 140. In other examples, the pool may be shared and contention for memory in the reserved pool may be handled by a memory controller 170, or by one or more of the processors.

Upon creation of a first worker thread 142, the worker processor 140 may allocate memory from the reserved pool 182 for the stack of the first worker thread 142 — for example, a first thread stack space 184. First worker thread 142 may then utilize this memory for stack space or other uses. In some examples, one or more worker threads, such as a first worker thread 142 may spawn additional worker threads, such as a second worker thread 144. Upon creating the second worker thread 144, the worker processor 140 may obtain additional memory space on the reserved pool 182—for example, a second thread stack space 186.

In some examples, if the reserved pool 182 does not have enough free memory to allocate additional stack space for a newly spawned thread, the worker processor may not create a new worker thread and may return an error to the worker thread or host process that requested a new thread. In other examples, the system (e.g., the worker processor) may send a message to the host process 122 or other software on the host processor 120 requesting additional space in the reserved pool 182. The host processor 120 may allocate additional space to the reserved pool (if available) and the new worker thread may then be assigned sufficient stack memory and may be executed. The additional space may be allocated by the host processor messaging the worker processor as well as reserving the additional space in a memory table that tracks which memory is allocated to which processors and which processes. lithe host processor 120 does not allocate additional space or if there is not sufficient space in the reserved pool 182, the host processor (e.g., the host process 122) may terminate one or more other worker threads to free up space or may send a message denying the request for an increased reserved pool. In some examples, if the request for additional space in the reserved pool is denied the proposed new thread is not created and a failure may be sent to the thread or process that requested the new thread.

While the present disclosure describes allocating stack memory, one of ordinary skill in the art with the benefit of the present disclosure will appreciate that the disclosed methods may be applicable to other types of memory allocations (e.g., heap memory).

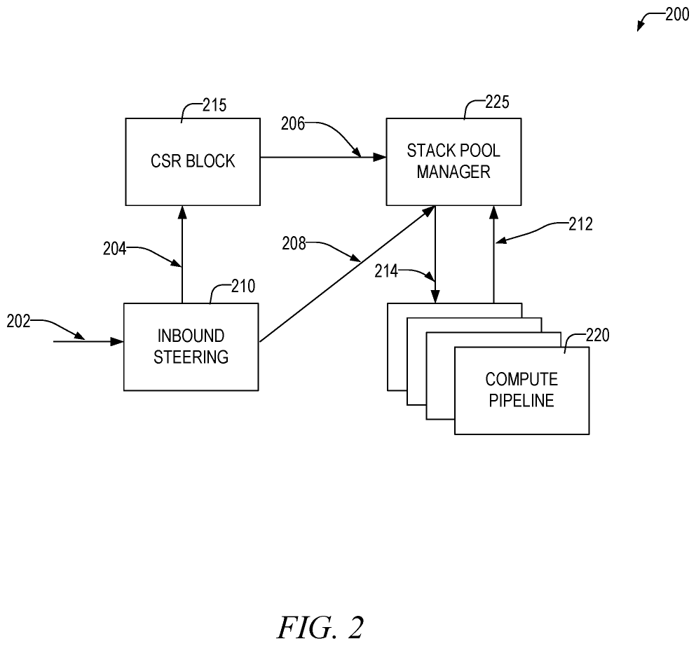

FIG. 2 illustrates a logical flow 200 of reserving a stack pool according to some examples of the present disclosure. In some examples, the components shown in FIG. 2 may be logical components within a single worker processor. In other examples, one or more components may be implemented by one or more other devices, processors, or silicon chips. A reservation request 202 for a pool of memory is received by inbound steering component 210. Inbound steering may receive the reservation request 202 and in response, initialize a configuration status register (CSR) 215 at operation 204. The CSR may be used to track an address of the memory pool for a particular process. In some examples the processor may exclusively execute one or more worker threads of a single host process. In other examples, the processor may execute one or more threads of one or more different host processes. In the latter examples, the CSR 215 may store multiple memory addresses for multiple pools belonging to different processes. The memory addresses may be indexed by a process identifier.

When a new thread is launched, a new thread exits the worker processor (e.g., processor 140) to be sent to a load balancer which forwards the thread to a worker processor (either a same worker processor such as worker processor 140 or a different worker processor). The inbound steering component 210 of the assigned processor may query the stack pool manager 225 to assign stack memory resources at message 208. The stack pool manager 225 may receive the stack pool information from the CSR 215 at operation 206 to ascertain the available memory pool for the executing process of the new thread and then determine which of that memory has not yet been assigned. The stack pool manager 225 then assigns stack memory to the executing thread and returns that information to the compute pipeline 220 at message 214. In some examples, the stack pool manager 225 may not need information from the CSR block 215 as the stack pool manager 225 may be both the master of the pools as well as the storage of information about the pools. In these examples, as new threads are created, to query for resources, the stack pool manager 225 may respond directly without consulting the CSR block 215. Once a thread terminates, the stack memory allocated to that thread is freed at message 212.

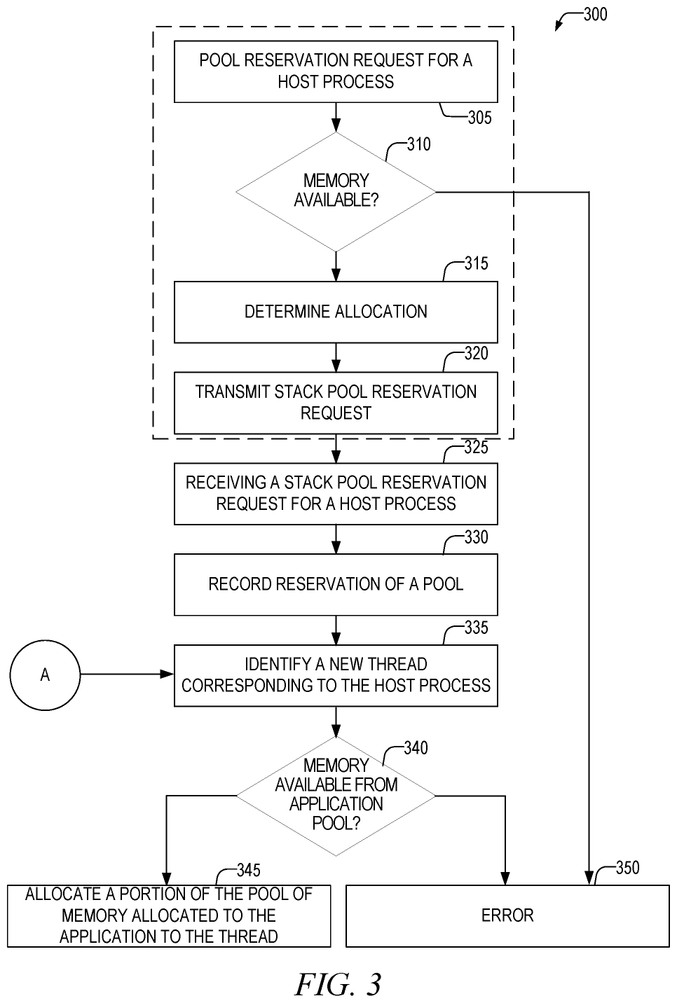

FIG. 3 illustrates a flowchart of a method 300 of allocating memory, such as stack memory, for threads of a host process according to some examples of the present disclosure. At operation 305, the host process executing on the host processor, may request a pool of memory for use by worker threads of a host process. In some examples, the memory may include stack memory, available to a worker processor that may execute one or more worker threads. The worker processor may be a processor that is different from the host processor and may be communicatively coupled to the host processor over a communication interface, such as a PCI-e interface. In some examples, the communication interface is a slower interface than an interface that connects the host processor to RAM used by the host processor to execute the host process and other instructions. The memory that is reserved may be a different memory than a main memory (RAM) used by the host process and may be on a separate processing module or device (e.g., the compute device 110). In some examples, the reservation may be made by the host process executing on the host processor by communicating with a driver module of an operating system executing on the host processor.

The host processor (e.g., a driver) may then determine if memory is available on the processing device at operation 310. If memory is not available, or not enough memory is available, then at operation 350 an error may be indicated. In some examples, the request from the host process may specify a size requested. In other examples, the size may be a fixed prespecified size. In some examples, if some memory is available but not all of the requested memory pool, a smaller amount may be allocated, and this may be indicated to the host process. If memory is available at operation 310, then at operation 315 the allocation may be determined. That is, the memory addresses or ranges necessary to fill the allocation request may be identified and reserved in a memory management table on the host processor. At operation 320, the host processor may then transmit the allocation to one or more processors on the compute device in the form of a stack pool allocation request which may identify the reserved memory, the size of the reserved memory, and/or the host process.

In some examples, the host process may specify which of one or more processors of the compute device (e.g., compute device 110) which may execute worker threads of the host process. Each processor may then receive a pool of memory with which to allocate stack from when a new thread is created for the host process. The memory so allocated may be provided to each processor via messaging across the host interface. The processors may then store information on the reserved memory pool along with the host process identifier to cause the reservation of the pool.

The remaining operations of FIG. 3 may then be executed by the worker processors on the compute device. At operation 325, the worker processor may receive the stack pool reservation request. In some examples, the worker processor may be exclusively reserved by the host process. In these examples, the reservation message may not specify a process identifier. In other examples, the worker processor may handle tasks from multiple processes. In these examples, the message may include a process identifier. At operation 330, the processor may record the reservation of the memory pool. For example, by setting a configuration status register (CSR). For examples in which a worker processor may execute threads of more than one host process, the CSR may be configured to store multiple reservations. Each reservation may identify the reserved memory and a process identifier.

At operation 335, the worker processor may identify a new thread corresponding to the host process. For example, the host process may send a message with executable code to begin execution on the worker processor. In other examples, an already executing worker thread on the worker processor may cause execution by the worker processor of an instruction to spawn a new thread. In still other examples, a new thread may send a request for stack memory. This new thread may be spawned without the involvement of the host process or host processor. At operation 340, a determination is made whether there is sufficient free memory from the reserved pool. If not, then at operation 350 an error condition is indicated. If there is sufficient free memory, then at operation 345 a portion of the pool is allocated for the newly created thread. The allocated memory may be recorded in a configuration status register, or other data structure. The CSR or other data structure may track which threads (e.g., identified by a thread identifier) are allocated which portions of the reserved pool. In some examples, the operations of creating the new thread and assigning the portion of the pool of memory to the new thread is performed without intervention from the host processor.

In some examples, the amount of memory to allocate may be prespecified and may be a same amount for all threads. In other examples, the new thread or the executable code that created the thread (either the host process or the parent worker thread) may specify an amount of memory. In still other examples, the amount to grant to each thread may be specified in the reservation request sent at operation 320 and received at operation 325.

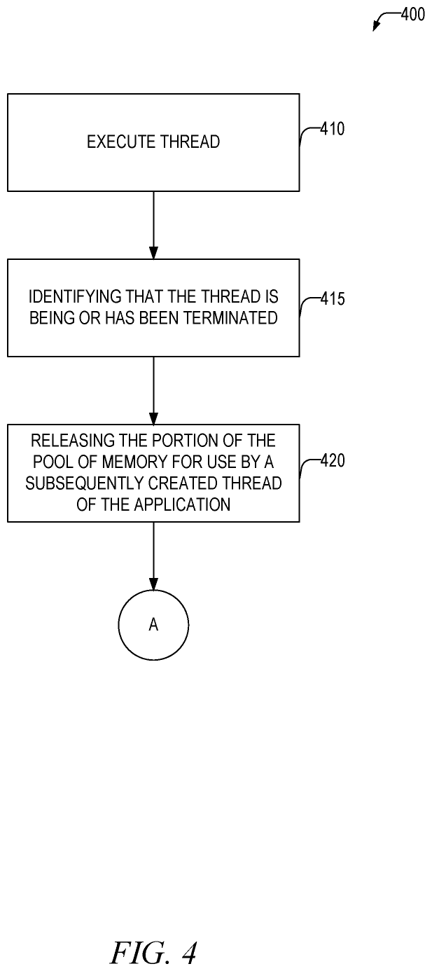

FIG. 4 illustrates a flowchart of a method 400 of a thread executing on a worker processor according to some examples of the present disclosure. At operation 410, the worker thread executes. Operation 410 may comprise executing one or more instructions of the thread. The operation 415, the worker processor may identify that the thread has terminated or will be terminated. For example, the worker processor may identify an exception or other fault that terminated the worker thread. In other examples, the thread may have completed its work and signaled its intention to relinquish its memory and/or processing resources. For example, the thread may call a specified function to complete its execution (e.g., an exit( ) function).

At operation 420, the worker processor may release the portion of the pool of memory for use by a subsequently created thread of the host application. In some examples, the subsequently created thread may be a thread created by a different thread of the host application or a thread created directly by the host application. Operation 420 may be accomplished by changing one or more data structures that track which threads are allocated which sections of the memory pool for the host application.

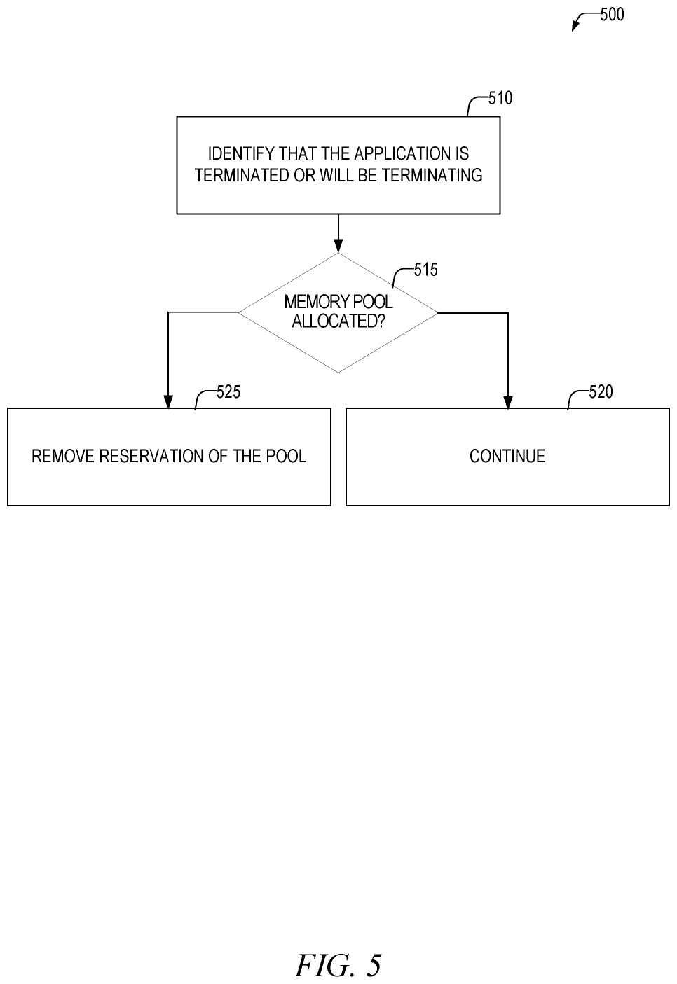

FIG. 5 illustrates a flowchart of a method 500 of releasing the pool of reserved memory for the host application according to some examples of the present disclosure. At operation 510 the system may identify that the host application is terminated or will be terminating. For example, the host processor may identify an exception or other fault that terminated the host process. In other examples, the host process may have completed its work and signaled its intention to relinquish its memory and/or processing resources. For example, the thread may call a specified function to complete its execution (e.g., an exit( ) function). At operation 515, a determination may be made as to whether the host application had allocated a memory pool on one or more worker processors. If there are no memory pools allocated, then processing continues with the host process cleanup at operation 520. If there are memory pools, then at operation 525 the reservations are cancelled. For example, reservations on physical processor time of one or more host processors are freed as well as any memory pools for threads on those host processors.

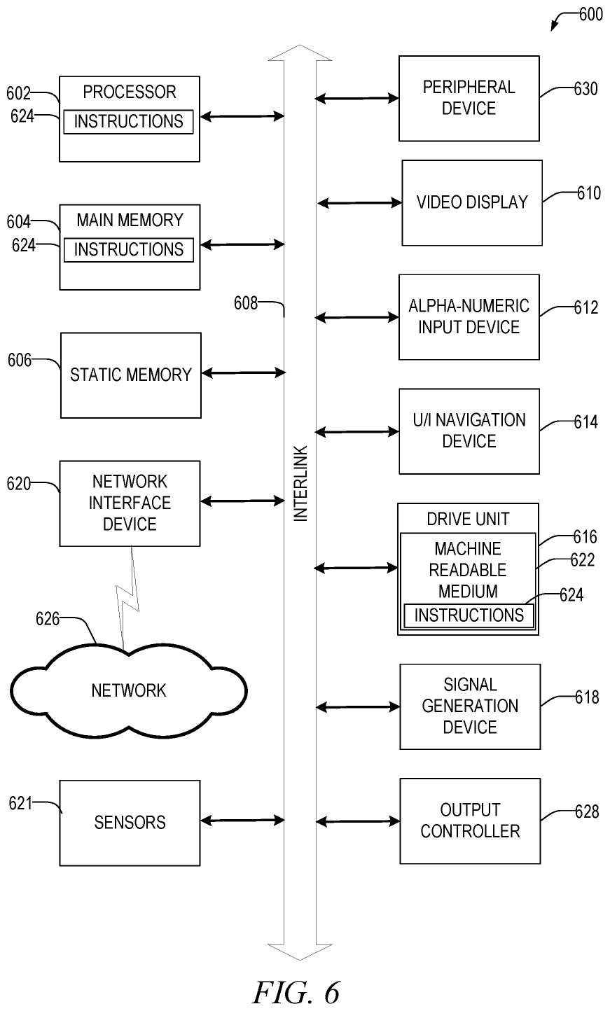

FIG. 6 illustrates a block diagram of an example machine 600 upon which any one or more of the techniques (e.g., methodologies) discussed herein may be performed. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. Machine 600 may be a host device and processor 602 may be an example of a host processor (such as host processor 120). Host process 122 may be an example of instructions 624. Host interface 125 may be an example of an interlink 608. Compute device 110 may be an example of peripheral device 630. In addition, one or more of the components of machine 600 may be included in or configured to implement compute device 110. The machine 600 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 600 may include one or more hardware processors, such as processor 602. Processor 602 may be a central processing unit (CPU), a graphics processing unit (GPU), a hardware processor core, or any combination thereof. Machine 600 may include a main memory 604 and a static memory 606, some or all of which may communicate with each other via an interlink (e.g., bus) 608. Examples of main memory 604 may include Synchronous Dynamic Random-Access Memory (SDRAM), such as Double Data Rate memory, such as DDR4 or DDR5. Interlink 608 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.). Machine 600 may also include a peripheral device 630 such as a graphics processing unit, a video capture card, a compute device with additional processors and other computational resources, and the like.

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 624 may further be transmitted or received over a communications network 626 using a transmission medium via the network interface device 620. The Machine 600 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques.

### OTHER NOTES AND EXAMPLES

Example 1 is a method comprising: receiving, at a first processor, a stack pool reservation request from a host process executing on a second processor, the stack pool reservation request received across a host interface, the stack pool reservation request requesting a reservation of a pool of stack memory of a computing device for the host process; causing, at the first processor, reservation of the pool of memory corresponding to the stack pool reservation request; creating, by the first processor, a new thread corresponding to the host process, the new thread to be executed on the first processor; and assigning, by the first processor, a portion of the pool of memory to the new thread.

In Example 2, the subject matter of Example 1 includes, identifying that the new thread has ceased executing; and responsive to identifying that the new thread has ceased executing, releasing the portion of the pool of memory for use by a subsequently created thread of the host process.

In Example 3, the subject matter of Examples 1-2 includes, wherein the operations of creating, by the first processor, the new thread is executed responsive to a new thread creation command from an already existing thread executing on the first processor.

In Example 4, the subject matter of Examples 1-3 includes, wherein the operations of creating, by the first processor, the new thread is executed responsive to a new thread creation command from the host process on the second processor.

In Example 5, the subject matter of Examples 1-4 includes, wherein causing reservation of the pool of memory comprises setting a configuration status register.

In Example 6, the subject matter of Examples 1-5 includes, wherein the first processor executes a RISC-V instruction set.

In Example 7, the subject matter of Examples 1-6 includes, wherein the first processor is one of a plurality of processors on a device communicatively coupled to a host device.

In Example 8, the subject matter of Examples 1-7 includes, wherein the host interface is a Peripheral Component Interconnect Express (PCI-e) interface.

In Example 9, the subject matter of Examples 1-8 includes, wherein the operations of performed without intervention from the second processor.

Example 10 is a computing device comprising: a first processor configured to perform operations comprising: receiving a stack pool reservation request from a host process executing on a second processor, the stack pool reservation request received across a host interface, the stack pool reservation request requesting a reservation of a pool of stack memory of a computing device for the host process; causing reservation of the pool of memory corresponding to the stack pool reservation request; creating, by the first processor, a new thread corresponding to the host process, the new thread to be executed on the first processor; and assigning a portion of the pool of memory to the new thread.

In Example 11, the subject matter of Example 10 includes, identifying that the new thread has ceased executing; and responsive to identifying that the new thread has ceased executing, releasing the portion of the pool of memory for use by a subsequently created thread of the host process.

In Example 12, the subject matter of Examples 10-11 includes, wherein the operations of creating, by the first processor, the new thread is executed responsive to a new thread creation command from an already existing thread executing on the first processor.

In Example 13, the subject matter of Examples 10-12 includes, wherein the operations of creating, by the first processor, the new thread is executed responsive to a new thread creation command from the host process on the second processor.

In Example 14, the subject matter of Examples 10-13 includes, wherein causing reservation of the pool of memory comprises setting a configuration status register.

In Example 15, the subject matter of Examples 10-14 includes, wherein the first processor executes a RISC-V instruction set.

In Example 16, the subject matter of Examples 10-15 includes, wherein the first processor is one of a plurality of processors on a device communicatively coupled to a host device.

In Example 17, the subject matter of Examples 10-16 includes, wherein the host interface is a Peripheral Component Interconnect Express (PCI-e) interface.

In Example 18, the subject matter of Examples 10-17 includes, wherein the operations of performed without intervention from the second processor.

Example 19 is a non-transitory machine-readable medium, storing instructions, which when executed by a first processor, causes the first processor to perform operations comprising: receiving a stack pool reservation request from a host process executing on a second processor, the stack pool reservation request received across a host interface, the stack pool reservation request requesting a reservation of a pool of stack memory of a computing device for the host process; causing reservation of the pool of memory corresponding to the stack pool reservation request; creating, by the first processor, a new thread corresponding to the host process, the new thread to be executed on the first processor; and assigning a portion of the pool of memory to the new thread.

In Example 20, the subject matter of Example 19 includes, identifying that the new thread has ceased executing; and responsive to identifying that the new thread has ceased executing, releasing the portion of the pool of memory for use by a subsequently created thread of the host process.

In Example 21, the subject matter of Examples 19-20 includes, wherein the operations of creating, by the first processor, the new thread is executed responsive to a new thread creation command from an already existing thread executing on the first processor.

In Example 22, the subject matter of Examples 19-21 includes, wherein the operations of creating, by the first processor, the new thread is executed responsive to a new thread creation command from the host process on the second processor.

In Example 23, the subject matter of Examples 19-22 includes, wherein causing reservation of the pool of memory comprises setting a configuration status register.

In Example 24, the subject matter of Examples 19-23 includes, wherein the first processor executes a RISC-V instruction set.

In Example 25, the subject matter of Examples 19-24 includes, wherein the first processor is one of a plurality of processors on a device communicatively coupled to a host device.

In Example 26, the subject matter of Examples 19-25 includes, wherein the host interface is a Peripheral Component Interconnect Express (PCI-e) interface.

In Example 27, the subject matter of Examples 19-26 includes, wherein the operations of performed without intervention from the second processor.

Example 28 is a computing device comprising: performing, using a first processor, operations comprising: means for receiving a stack pool reservation request from a host process executing on a second processor, the stack pool reservation request received across a host interface, the stack pool reservation request requesting a reservation of a pool of stack memory of a computing device for the host process; means for causing reservation of the pool of memory corresponding to the stack pool reservation request; means for creating, by the first processor, a new thread corresponding to the host process, the new thread to be executed on the first processor; and means for assigning a portion of the pool of memory to the new thread.

In Example 29, the subject matter of Example 28 includes, means for identifying that the new thread has ceased executing; and responsive to identifying that the new thread has ceased executing, means for releasing the portion of the pool of memory for use by a subsequently created thread of the host process.

In Example 30, the subject matter of Examples 28-29 includes, wherein the means for creating, by the first processor, the new thread is executed responsive to a new thread creation command from an already existing thread executing on the first processor.

In Example 31, the subject matter of Examples 28-30 includes, wherein the means for creating, by the first processor, the new thread is executed responsive to a new thread creation command from the host process on the second processor.

In Example 32, the subject matter of Examples 28-31 includes, wherein the means for causing reservation of the pool of memory comprises means for setting a configuration status register.

In Example 33, the subject matter of Examples 28-32 includes, wherein the first processor executes a RISC-V instruction set.

In Example 34, the subject matter of Examples 28-33 includes, wherein the first processor is one of a plurality of processors on a device communicatively coupled to a host device.

In Example 35, the subject matter of Examples 28-34 includes, wherein the host interface is a Peripheral Component Interconnect Express (PCI-e) interface.

In Example 36, the subject matter of Examples 28-35 includes, wherein the means for performed without intervention from the second processor.

Example 37 is at least one machine-readable medium including instructions that, when executed by processing circuitry, cause the processing circuitry to perform operations to implement of any of Examples 1-36.

Example 38 is an apparatus comprising means to implement of any of Examples 1-36.

Example 39 is a system to implement of any of Examples 1-36.

Example 40 is a method to implement of any of Examples 1-36.

What is claimed is:

1. A method comprising:
receiving, at a first processor, a stack pool reservation request from a host process executing on a second processor, the stack pool reservation request received across a host interface, the stack pool reservation request requesting a reservation of a pool of stack memory of a computing device for the host process;
causing, at the first processor, reservation of the pool of memory corresponding to the stack pool reservation request;
creating, by the first processor, a new thread corresponding to the host process, the new thread to be executed on the first processor; and
assigning, at the first processor, a portion of the pool of memory to the new thread.

2. The method of claim 1, further comprising:
identifying that the new thread has ceased executing; and
responsive to identifying that the new thread has ceased executing, releasing the portion of the pool of memory for use by a subsequently created thread of the host process.

3. The method of claim 1, wherein the operations of creating, by the first processor, the new thread is executed responsive to a new thread creation command from an already existing thread executing on the first processor.

4. The method of claim 1, wherein the operations of creating, by the first processor, the new thread is executed responsive to a new thread creation command from the host process on the second processor.

5. The method of claim 1, wherein causing reservation of the pool of memory comprises setting a configuration status register.

6. The method of claim 1, wherein the first processor executes a RISC-V instruction set.

7. The method of claim 1, wherein the first processor is one of a plurality of processors on a device communicatively coupled to a host device.

8. The method of claim 1, wherein the host interface is a Peripheral Component Interconnect Express (PCI-e) interface.

9. The method of claim 1, wherein the operations of creating the new thread and assigning the portion of the pool of memory to the new thread is performed without intervention from the second processor.

10. A computing device comprising:
a first processor configured to perform operations comprising:
receiving a stack pool reservation request from a host process executing on a second processor, the stack pool reservation request received across a host interface, the stack pool reservation request requesting a reservation of a pool of stack memory of a computing device for the host process;
causing reservation of the pool of memory corresponding to the stack pool reservation request;
creating, by the first processor, a new thread corresponding to the host process, the new thread to be executed on the first processor; and
assigning a portion of the pool of memory to the new thread.

11. The computing device of claim 10, further comprising:
identifying that the new thread has ceased executing; and
responsive to identifying that the new thread has ceased executing, releasing the portion of the pool of memory for use by a subsequently created thread of the host process.

12. The computing device of claim 10, wherein the operations of creating, by the first processor, the new thread is executed responsive to a new thread creation command from an already existing thread executing on the first processor.

13. The computing device of claim 10, wherein the operations of creating, by the first processor, the new thread is executed responsive to a new thread creation command from the host process on the second processor.

14. The computing device of claim 10, wherein causing reservation of the pool of memory comprises setting a configuration status register.

15. The computing device of claim 10, wherein the operations of creating the new thread and assigning the portion of the pool of memory to the new thread is performed without intervention from the second processor.

16. A non-transitory machine-readable medium, storing instructions, which when executed by a first processor, causes the first processor to perform operations comprising:
receiving a stack pool reservation request from a host process executing on a second processor, the stack pool reservation request received across a host interface, the stack pool reservation request requesting a reservation of a pool of stack memory of a computing device for the host process;
causing reservation of the pool of memory corresponding to the stack pool reservation request;
creating, by the first processor, a new thread corresponding to the host process, the new thread to be executed on the first processor; and
assigning a portion of the pool of memory to the new thread.

17. The non-transitory machine-readable medium of claim 16, further comprising:
identifying that the new thread has ceased executing; and
responsive to identifying that the new thread has ceased executing, releasing the portion of the pool of memory for use by a subsequently created thread of the host process.

18. The non-transitory machine-readable medium of claim 16, wherein the operations of creating, by the first processor, the new thread is executed responsive to a new thread creation command from an already existing thread executing on the first processor.

19. The non-transitory machine-readable medium of claim 16, wherein the operations of creating, by the first processor, the new thread is executed responsive to a new thread creation command from the host process on the second processor.

20. The non-transitory machine-readable medium of claim 16, wherein the operations of creating the new thread and assigning the portion of the pool of memory to the new thread is performed without intervention from the second processor.
